(19) United States
(12) Patent Application Publication
(10) Pub. No.: US 2020/0397185 A1
(43) Pub. Date: Dec. 24, 2020

(54) BABY FOOD MAKER

(71) Applicant: Appliance Development Corporation, Danvers, MA (US)

(72) Inventors: Dov Z. Glucksman, Winchester, MA (US); Michael David Miller, Tewskbury, MA (US); Ping Chuen Chow, Hong Kong (CN); Jianchang Ma, Guangdong (CN)

(21) Appl. No.: 17/013,816

(22) Filed: Sep. 7, 2020

Related U.S. Application Data
(63) Continuation-in-part of application No. 62/480,402, filed on Apr. 1, 2017.
Application No. 62/480,402 is a continuation-in-part of application No. 62/360,998, filed on Jul. 12, 2016.
Application No. 62/360,998 is a continuation-in-part of application No. 15/646,441, filed on Jul. 11, 2017, now Pat. No. 10,765,249.

(51) Int. Cl. A47J 36/24; A47J 27/04; A47J 27/00; A47J 43/046

(52) U.S. Cl. CPC A47J 36/2433; A47J 27/04; A47J 2027/043; A47J 43/046; A47J 27/004

(57) ABSTRACT

A method and apparatus for steaming and blending food products, also usable for sterilizing articles such as baby pacifiers and bottles as needed. The apparatus includes a base including a removable steam chamber and a motor driven drive shaft. A container assembly including a blade assembly can be mounted to the base for steaming the food and for blending the food. The apparatus may further include a steam diverter plate for sterilizing articles such as baby bottles.

### RELATED APPLICATION

This application claims priority to US Provisional Applications Nos 62/360,998 filed on 12 Jul. 2016 and 62/480,402 filed on 1 Apr. 2017, and is a Continuation-in-Part of U.S. application Ser. No. 15/646,441 filed on 11 Jul. 2017, the teachings of which are all incorporated herein in their entireties by reference.

### FIELD OF THE INVENTION

This invention relates to an apparatuses and methods for steaming and blending food products.

### BACKGROUND OF THE INVENTION

Various appliances have been designed for steaming and/or blending food products. Baby food is often made by steaming food products and then placing them in a blender. While two separate appliances, namely a steamer and a blender, can be employed for making pureed food such as baby food, some appliances have been designed that provide both such functions. U.S. Pat. Nos. 6,076,452, 7,617,766 and 6,550,372 and US Publications Nos. 20130032038, 20140305321 and 20140252146 disclose food processing devices that allow the use of one appliance to steam food products and blend it.

Appliances have also been designed for sterilizing baby bottles. Some sterilizers intended for this purpose have employed steam. U.S. Pat. Nos. 4,544,529 and 5,213,776 disclose such sterilizing appliances.

Since steam is generated within the appliance intended for steaming and/or blending food products it had become apparent that the same appliance could be used for heating or sterilizing baby bottles and other items babies would place in their mouths. U.S. Pat. No. 7,617,766 discloses an appliance designed to perform both functions.

### SUMMARY OF THE INVENTION

The present invention is directed to an apparatus and a method for steaming and blending food products. An apparatus in accordance with the invention includes a base having a support for a container. A steam chamber is removably supported by the base and includes a steam exit port. A heater to heat water in the removable steam chamber. A drive shaft extends vertically upwards, rotatably supported by the base and an electric motor is provided for rotating the drive shaft. The apparatus further includes a container assembly including a container, and a lid removably coupled to the top end portion of the container. A steam inlet passage is provided in the container for allowing the entrance of steam generated within the steam chamber. A blade assembly is disposed within the container. The container assembly is mountable to the base.

A method in accordance with the invention includes the steps of providing a base having a support for a container. A steam chamber is removably supported by the base and includes a steam exit port. A heater to heat water in the removable steam chamber. A drive shaft extends vertically upwards, rotatably supported by the base and an electric motor is provided for rotating the drive shaft. The apparatus further includes a container assembly including a container, and a lid removably coupled to the top end portion of the container. A steam inlet passage is provided in the container for allowing the entrance of steam generated within the steam chamber. A blade assembly is disposed within the container. The container assembly is mountable to the base. The method further includes placing the container on the base, introducing food into the container, causing the steam chamber to produce steam, the steam entering the container through the steam inlet passage and steaming the food, and actuating the motor to cause rotation of the drive shaft and coupled blade assembly, thereby blending the food.

A food preparation assembly is further provided in accordance with the invention. The assembly includes an apparatus for steaming and blending food products. The apparatus in accordance with the invention includes a base having a support for a container. A steam chamber is removably supported by the base and includes a steam exit port. A heater to heat water in the removable steam chamber. A drive shaft extends vertically upwards, rotatably supported by the base and an electric motor is provided for rotating the drive shaft. The apparatus further includes a container assembly including a container comprising a base portion and a side wall portion, and a steam inlet passage is provided in the container for allowing the entrance of steam generated within the steam chamber, and a lid removably coupled to the top end portion of the container. A blade assembly is disposed within the container. The container assembly is mountable to the base. A steam diverter plate is selectively positioned in the container. The steam diverter plate comprises a horizontal plate portion proximate said container base portion, including apertures, and a cap portion covering the steam inlet passage whereby steam diverter plate diverts steam from steam inlet passage into the space formed between chamber base portion and the horizontal plate portion of diverter plate. A plurality of bottles and other articles to be sterilized may be placed on top of the horizontal plate portion so that they may be surrounded by steam emanating from apertures for heating and/or sterilizing.

### BRIEF DESCRIPTION OF THE DRAWINGS

FIG. 1 is a simplified sectional view of a baby food maker according to a first embodiment, showing all its components in place including food to be processed;

FIG. 2. is a simplified sectional view of the baby food maker of FIG. 1, configured to sterilize articles, showing all its components in place;

FIG. 3 is an isometric view of the gear motor of FIG. 1;

FIG. 4A is a cross sectional view of the steam chamber of the baby food steamer of FIG. 1;

FIG. 4B is a cross sectional view of the steam chamber of the baby food steamer along lines B-B of FIG. 4A;

FIG. 4C is a partial cross-sectional view of the steam chamber of the baby food steamer along lines C-C of FIG. 4B;

FIG. 4D is an enlarged cross-sectional view of selected area D-D the steam chamber of the baby food steamer of FIG. 4A;

FIG. 5 is an enlarged sectional view of the selected area A-A of FIG. 1 according to a preferred embodiment of the invention;

FIG. 6 is an exploded isometric view of the baby food maker of FIG. 1;

FIG. 7 is an isometric view of a baby food maker according to a second embodiment;

FIG. 8 is an exploded isometric view of the baby food maker of FIG. 7;

FIG. 9 is a cross sectional view of the baby food steamer along lines 9-9 of FIG. 7;

FIG. 10 include two views of the drive system used in second apparatus of the baby food maker according to the invention;

FIG. 11 is a partial cross-sectional view of the baby food steamer of FIG. 9;

FIG. 12 is another partial cross-sectional view of the baby food steamer of FIG. 9; and

FIG. 13 includes two views of the drive system used in second apparatus of the baby food maker according to the invention.

### DETAILED DESCRIPTION OF THE INVENTION

The detailed description which follows is directed to preferred embodiments of the invention and is not intended as limiting the invention to the specific structures disclosed. The invention should instead be construed in accordance with the claims that are appended.

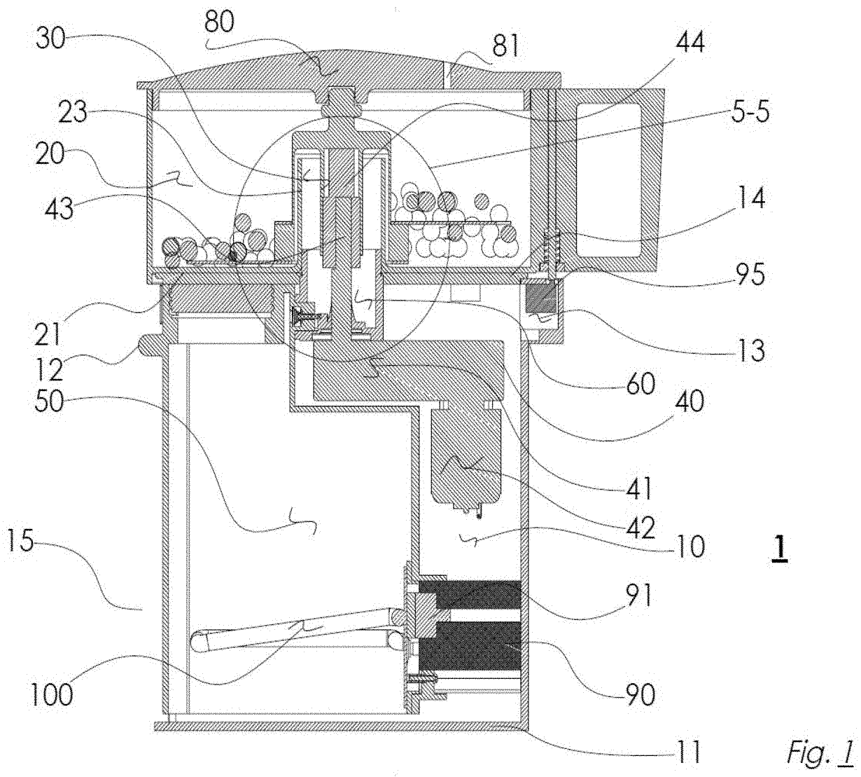

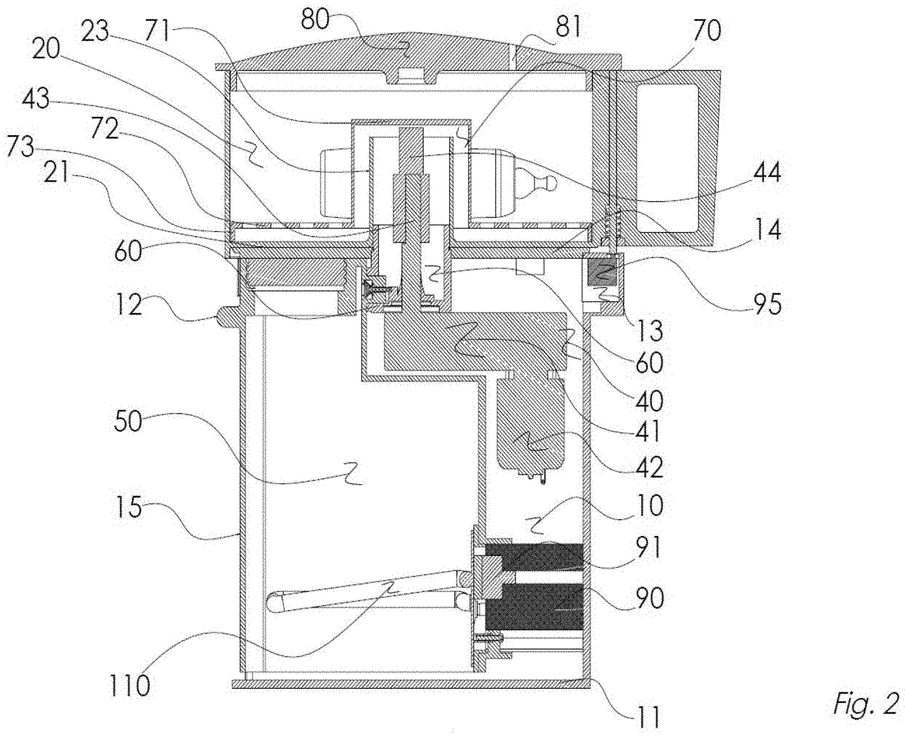

With reference to FIGS. 1 to 2, a first apparatus 1 according to the invention is provided. The apparatus can be used for making baby food or other types of pureed foods. As discussed below, it can also be adapted for sterilizing or warming baby bottles or other items such as pacifiers. A base 10 is provided for supporting and securing removable container 20, which, (securing the container to the base is achieved in a manner known in the art, such as a turning bayonet latch), and a gear-motor 40 for driving a blade assembly 30 or other blending device; and for providing means for a removable steam chamber 50 to be engaged and disengaged simultaneously with a steam conduit 60 and with electrical contact box 90.

Referring more specifically to FIGS. 1 and 2, the unit base 10 comprises a bottom 11 and side wall 15, with a top 14 secured to the top of the side wall with screws (not shown), a compartment 13 containing a safety switch 95, and a set of controls (not shown). The enclosure 11 supports the steam chamber 50 which is removable by the operator through opening 16 in unit base 10, for filling with water and for cleaning after use; unit base 10 also contains a gear motor assembly 40 terminating in drive shaft 43 extending upwards; unit base 10 also contains steam conduit 60 sealably connecting to steam outlet of steam chamber 50, when steam chamber is in its engaged position.

Compartment 13 contains a safety switch 95 controlling the operation of the gear motor, which is normally open and is only closed when both container 20 and lid 80 are in place and latched tightly to ensure the rotating blade assembly 30 cannot be accessed by operator.

Referring specifically to FIG. 2, which is like FIG. 1 in all but that the rotating blade assembly 30 is removed and a steam diverter 70 is placed in container 20 proximate its base portion 21. The steam diverter 70 comprises a steam dome section 71 extending above the drive shaft 44 and the inner collar 23 of container 20 thereby diverting steam into the space confined between the base portion 21 of container 20, and perforated plate portion 72 of steam diverter 70; note that the gap is determined by the size of the outer rim 73 of steam diverter 70. Lid 80 with vent opening 81 is shown coupled to container 20, to maintain the container 20 at elevated temperature and to limit the amount of steam allowed to escape during the sterilizing process.

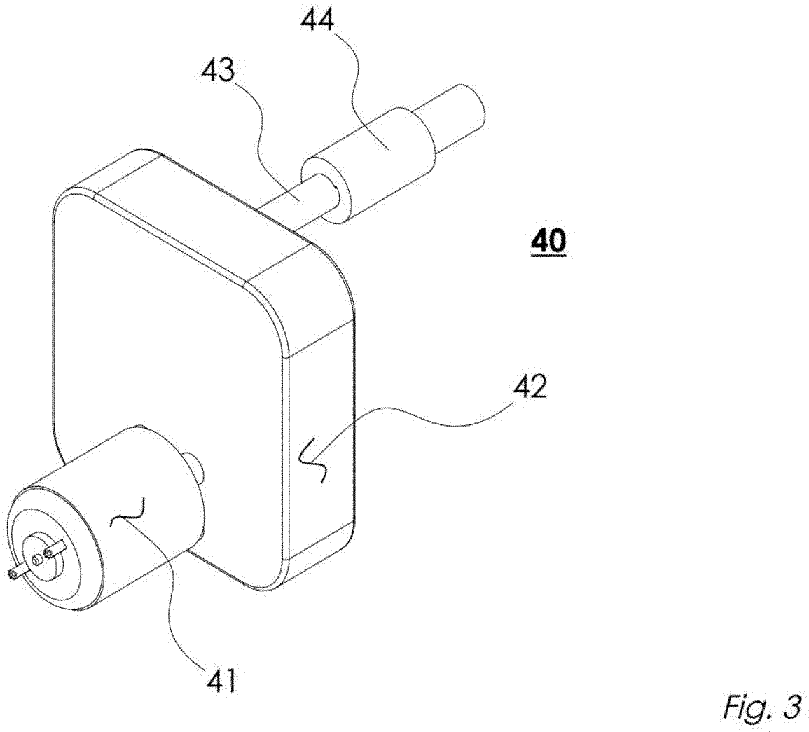

Referring specifically to FIG. 3, which is an isometric view of the gear motor assembly 40, illustrating an electric motor 41, which typically runs at high speed and low torque. This type of motor is chosen since it is compact and relatively low in cost. To use such a motor to drive the blade assembly of the baby food maker its speed must be reduced, and its torque increased by using a gear box 42, containing but not shown many gears chosen to achieve the rpm and torque required of the output shaft 43. Output shaft 43 is shown with a shaft extension 44 designed to transmit torque from the motor to the blade assembly 30.

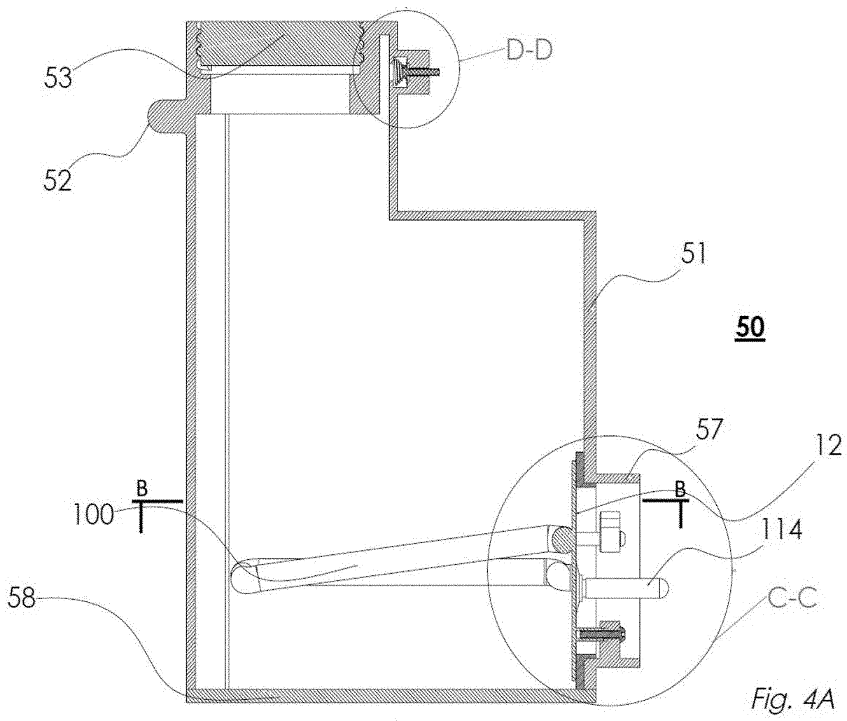

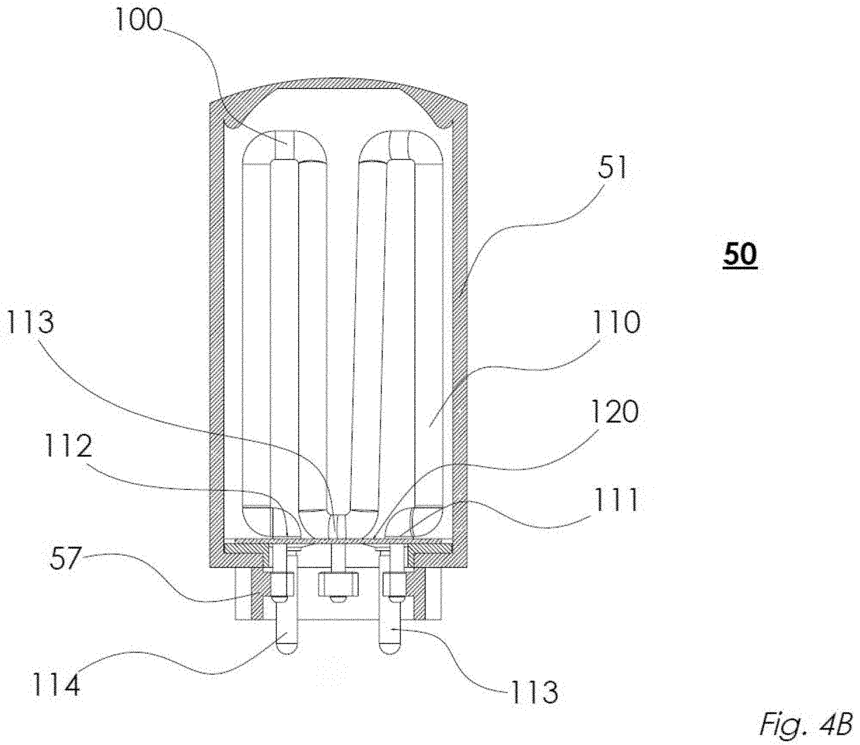

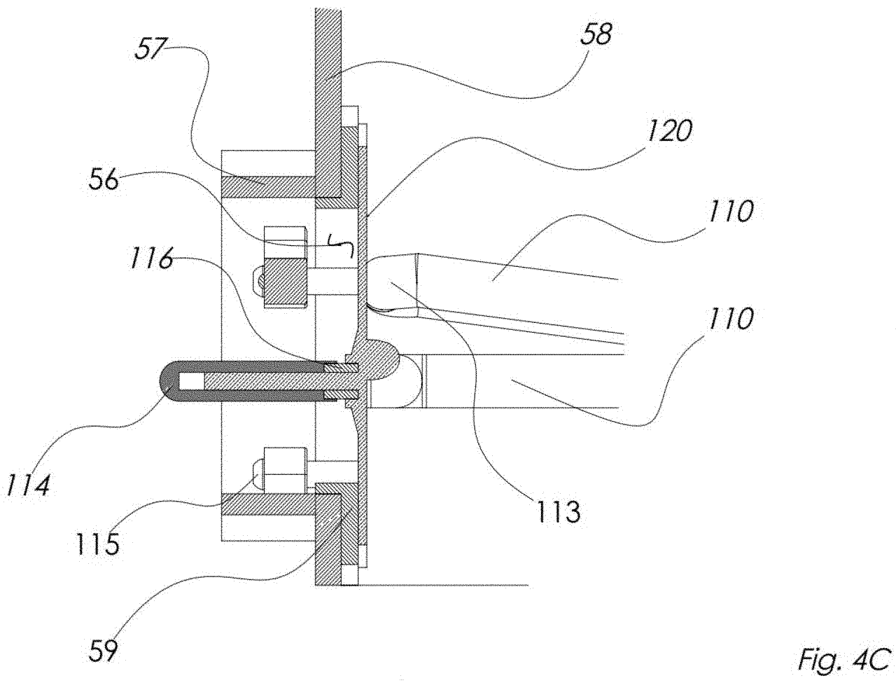

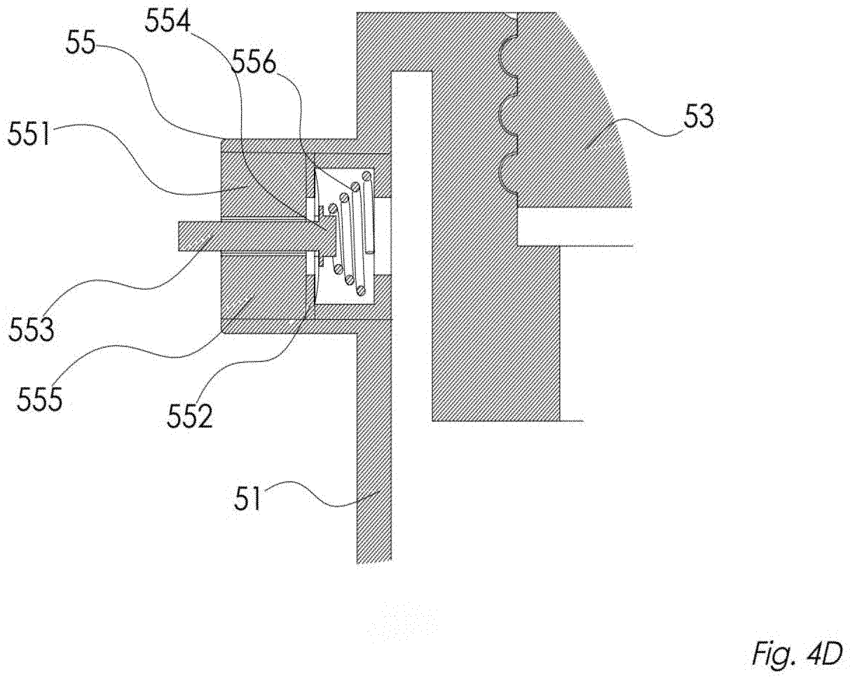

Referring to FIGS. 4A, B, C and D which illustrate several aspects of the steam chamber 50 consisting of a main body 51 made of high temperature plastic capable of withstanding the effects of steam and being free of contaminants (such a material is, for example, Tritan TX 2001 manufactured by Eastman Chemicals), and a bottom portion 58 secured to main body 51 by ultrasonic welding. The steam chamber includes an integrally molded handle 52 for pulling it out of base 10 of the baby food maker and a screwed-on cap 53 for filling the steam chamber with water. Steam chamber incorporates an immersion heater assembly 100 which is shown in greater detail in FIGS. 4 B and C. and a steam outlet assembly 55, shown in greater detail in FIG. 4D.

The heater assembly 100 comprises an elongated electric heating rod 110, shaped as a W with its two ends 111 and 112 brazed to a metal plate 120 and its middle portion 113, brazed to same metal plate 120. As shown in FIG. 4C the plate 120 is secured to the side wall of the main body 51 and spans an opening 56 in the enclosure 51. The plate 120 is secured by three screws that connect three threaded posts 115 integral to the plate 120 to three small flanges 58 integral to a short cylindrical member 57 molded from high temperature plastic. Cylindrical member 57 also serves to protect contact pins 114 and 115 from accidentally being bent while the steam chamber is outside the base 10. The plate 120 is spaced apart from the wall of the container 51 through a silicone part 59 which serves to isolate the hot plate from the plastic wall and to seal against water leakage. The contact pins 114 and 115 are of a commonly used design and are crimped to the terminals of the heater 110 and are electrically insulated using silicone bushings (not shown).

As shown in FIG. 4D the steam outlet 55 includes a valve assembly 551, comprising the valve seal 552 made of a flexible material such as silicone mounted on a valve stem 553, and a valve body comprising an annular valve seat 554 with four forwardly extending radial ribs 555 for supporting and guiding the valve stem as it slides back and forth. The valve is designed to remain normally shut by the force exerted on the seal by spring 556. When the steam chamber is pushed into the base 10 the stem is pushed back by a vertical rib 66 in the steam conduit 60 thereby maintaining the valve in an open position for delivering steam as it is generated in the steam chamber.

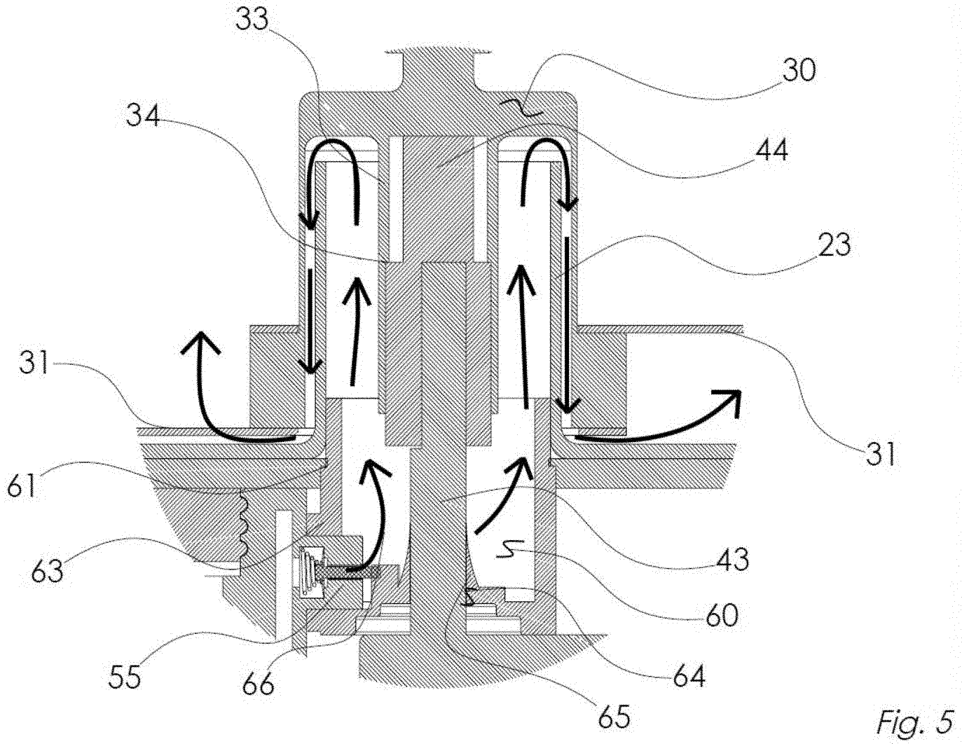

FIG. 5 shows in greater detail the steam conduits 60 used to conduct steam from the steam chamber to the bottom of the container for ensuring that all the food in the container is enveloped by steam. The steam conduit is a flexible molded part, preferably made from high temperature silicone. It comprises a vertical cylindrical portion 61 including a collar 63 extending sideward for receiving steam outlet 55 of steam chamber 50, in a sealable state. The conduit 60 further comprises a bottom member 62, which is rigidly connected to the gear box 42 so that its bottom opening 94 is aligned with the gear box shaft 43. A rotary seal 65 of a design known in the art is part of the bottom opening 64 and serves to engages the gear box shaft 43 to ensure that no steam escapes from the conduit down the shaft. A free-standing rib 66 rising from the bottom member 62 is positioned so it would push the steam 553 of the steam outlet back to overcome the force of the spring 556 thereby keeping the valve open for steam to flow into conduit and from there into the container 20. Series of arrows show the flow of steam from the steam outlet 55 through the conduit 60 and through the blade assembly hub, and out into the container 20, at a point near the base of the container, to ensure that it covers all food particles placed in the container. Blade assembly 30 comprises a shaft collar 33 designed to engage shaft extension 44 in a manner that allows it to slip in and out yet can transfer rotational torque from the gear motor shaft to the blades 31 and 32. Shown are a series of interlocking axial ribs 34 as one possible option.

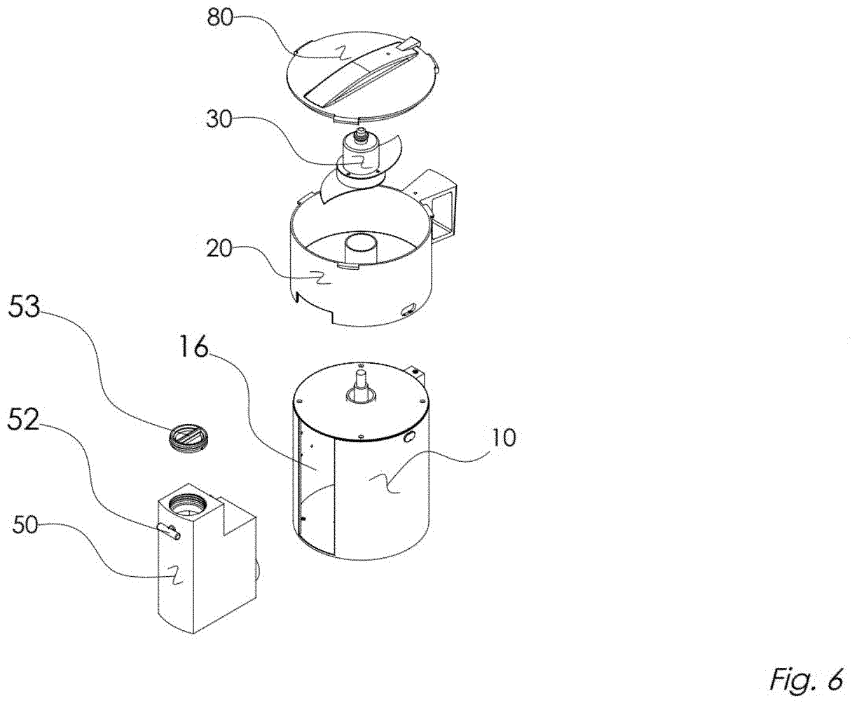

FIG. 6 shows the baby food maker with the steam chamber 50 removed from the base 10, and its cap removed as operator would do to fill it with fresh water. Also shown is the blade assembly 30 after being removed from the drive shaft to allow the container 20 to be lifted off the base as would be the case when the operator wants to wash the container. The lid 80 is also shown separated from the container, as would be the case when the user wishes to place food in the container or remove the cooked food from it.

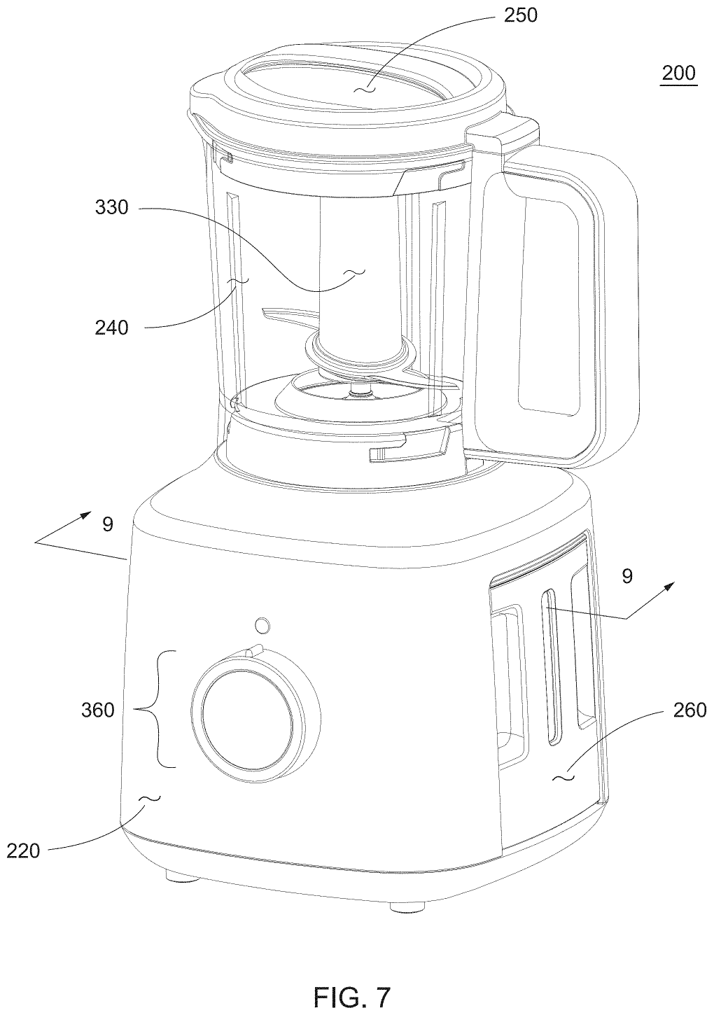

With reference to FIGS. 7 to 13, a second apparatus 200 according to the invention is provided. This apparatus can be used for making baby food or other types of pureed foods. As discussed previously, it can also be adapted for sterilizing or warming baby bottles or other items such as pacifiers.

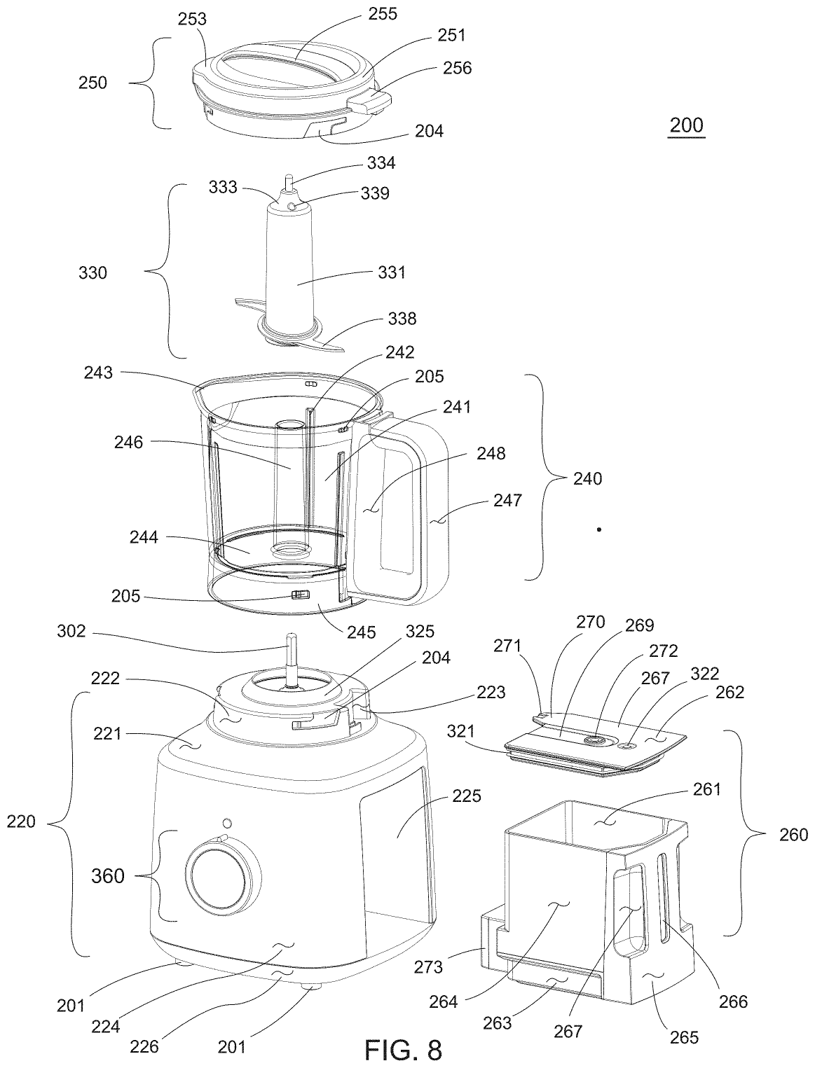

Referring to FIGS. 7 and 8, a base 220 is provided for supporting and securing removable container 240, being used for steaming and chopping food, including a blade assembly 330 for chopping food and a lid 250 secured to the top of the container. Base 220 also includes an electric motor and a drive assembly (not shown) terminating in drive shaft extension 302, which drives the blade assembly 330 chopping and meshing food within the container. The base also includes the electric controls required for the operation of the apparatus including the user-interface 360 extending out for easy access by the user. The base also includes a large open space 225 for containing a steam chamber 260. Not shown is an electric power cord needed for the operation of the apparatus.

The base 220 comprises a to top portion 221 including a cylindrical collar 222 containing a dog-leg shaped bayonet slot 204 for receiving and securing the container 240. The collar also includes a recess 223 designed to accommodate the container handle portion. The collar also includes a circular flexible seal 235 designed to align with the base of the container 244 when the container is coupled with the base. Side wall of the base 224 extends downward from the top 221, it includes the opening 225 for the steam chamber to slide into the base. A base plate 226 is attached to the bottom of the side wall 224. Also shown are feet 201 extending from the base plate.

The container 240, may be molded of transparent high temperature plastic capable of withstanding the effects of steam and being free of chemical-carcinogens, (such a material is, for example, Tritan TX 2002 manufactured by Eastman Chemicals). The container 240 comprises a side wall 241 with inwardly projecting vertical ribs 242 designed to help in the process of chopping food in a manner known in the art. The container also includes a pouring spout 243 and a base 244, a cylindrical skirt extends downwards from the base for aligning and securing the container to the base in a manner known in the art, such as a bayonet latch consisting of a key 205 which may slide into a dog-leg shaped slot 204, to be turned for securing the two parts to each other. An inner tube 246 extends upwardly from the center of the base to a height sufficient to prevent any liquids in the container to spill out. The container further includes a handle 247 and a vertically extending interlock channel 248 for containing and guiding an interlock rod, as shall be described further on.

The container is designed to receive a blade assembly 330 axially aligned with the upwardly extending tube 246. The blade assembly comprises an outer cylinder 331 an inner cylinder 332 (not shown) and a top portion 333 connecting the outer and inner cylinder in axial alignment, also shown is a small aperture 339 and an upwardly extending pin 334. The blade assembly includes cutting blade 338 which may be insert-molded as an integral part of the blade assembly.

A lid 250 is provided for safety and for sanitary considerations. The lid comprises a top 251, a downwardly extending side wall 252 with dog-leg shaped slots portions of a bayonet closure 204 and a spout cover 253; it also includes an extension 256, including an interlock actuator (not shown). A handle 255 is provided for allowing the user to lift and turn the lid as needed. It is a separate part from the lid and connected to it in a manner known in the art to ensure that it stays cool to the touch while the lid itself might reach temperatures close to 100 C during the operation of the appliance.

Also shown in FIGS. 7 and 8 is the steam chamber 260 including a water compartment 261, a steam chamber lid 262, an electrical heater and an electrical connector (both not shown). The steam chamber also includes a base portion 263 and a connector shield 273. The water compartment 261 includes a three-sided wall 264 and a front 265 secured to each other in a waterproof manner known in the art; the front includes a transparent window 266 for viewing the water level in the container, it also includes a pull handle portion 267. The lid 262 includes a lid top 270 with a downwardly extending side wall 268 including a seal track 269 for receiving and securing a flexible seal 321 designed to fit snugly against the inner wall of the water compartment 261; the lid also features a pressure relieve valve 322 designed to open when unsafe pressure is built up in the steam chamber due to some blockage in the path of the steam. The lid also includes an extension 271 for assisting the user in lifting the lid for filling or cleaning of the steam chamber. The extension 271 is also used to engage a switch (not shown) controlling the power to the steam chamber heater to ensure that steaming may only commence after the steam chamber is in proper alignment for the safe operation of the appliance.

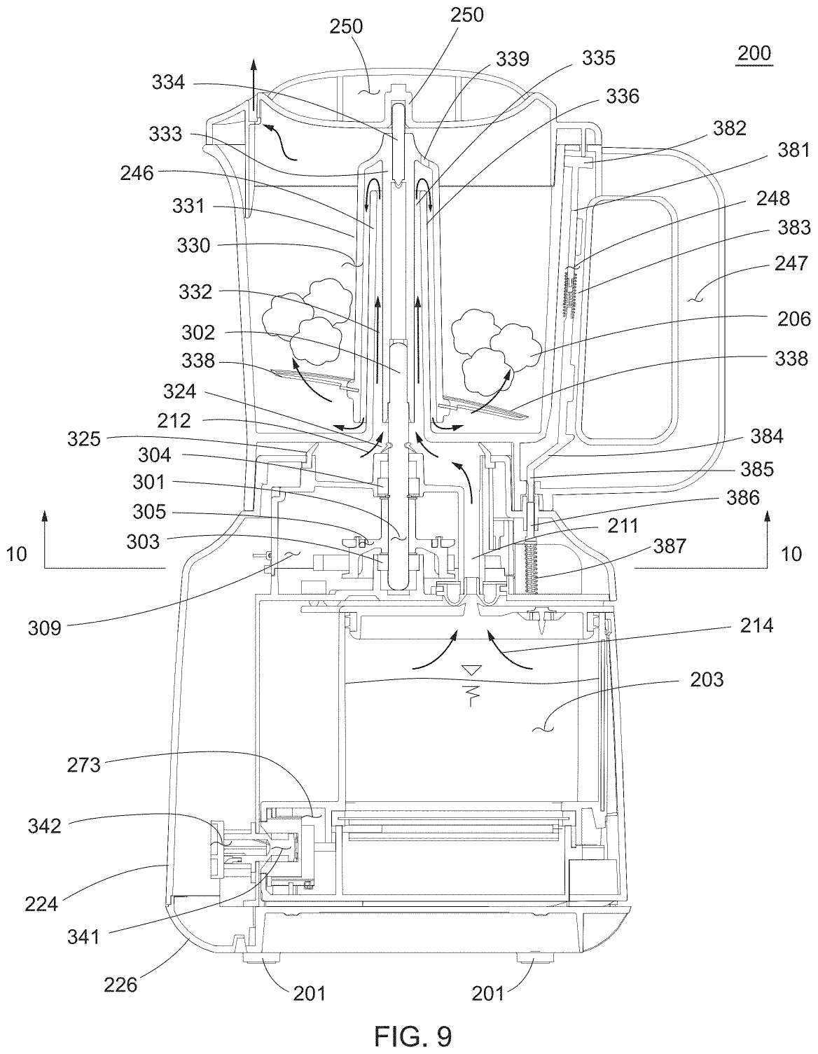

Referring to FIG. 9, which is a vertical cross sectional view of the apparatus 200, in which further details are shown to help explain certain aspects of the structure and operation of the appliance and how some of the structural details are present in order to improve performance and safety aspects.

A series of arrows 214 are included to help illustrate the steam flow which is generated from boiling water in the steam generator 260. Steam exits through the steam outlet 272 and flowing through the steam tube 211 into the steam plenum 212 which is sealed against the container base 244 by the upper seal 325, the steam flows up through the blade assembly's inner steam channel 335 and down through its outer steam channel 336, to emerge into the container, near its base, and below the food particles 206 which are partially suspended above the blade 338; excess steam may exit the container through a small opening 259 in the lid.

FIG. 9 also shows the safety-interlock details designed to ensure that the unit will not operate under conditions that could potentially harm the user. The interlock 380 consists of three portions that must be interconnected for the heater and/or the motor to be activated by the user. The first portion is located in the base 220 includes a normally open electrical switch (not shown) and a push-rod 386 normally biased away from the switch actuator by a spring 387. The second portion is located in the container interlock channel 248, comprising a push-rod 381 with a flat top 382, a spring 383 for biasing the pushrod upwards, a bent portion 384 terminating in a lower extension 585. The third portion is a rib 257, located in the lid extension 256 and designed to engage the flat top 382 of the second push rod 381 when the lid is locked in place over the container.

FIG. 9 also shows drive system 300 used to transmit power from the motor to the blade assembly which include the drive shaft 301 permanently affixed to the pully assembly 305 in a manner known in the art and driven by the belt 306. The shaft 301 is secured in place by a lower bearing 304 and an upper bearing 305, above which a rotary seal 324 is located to block any steam from entering the drive system compartment 309. The upper end 302 of the shaft 301 includes features for torque transmission to the blade assembly in a manner known in the art, such as splines, a number of flat surfaces, or the likes.

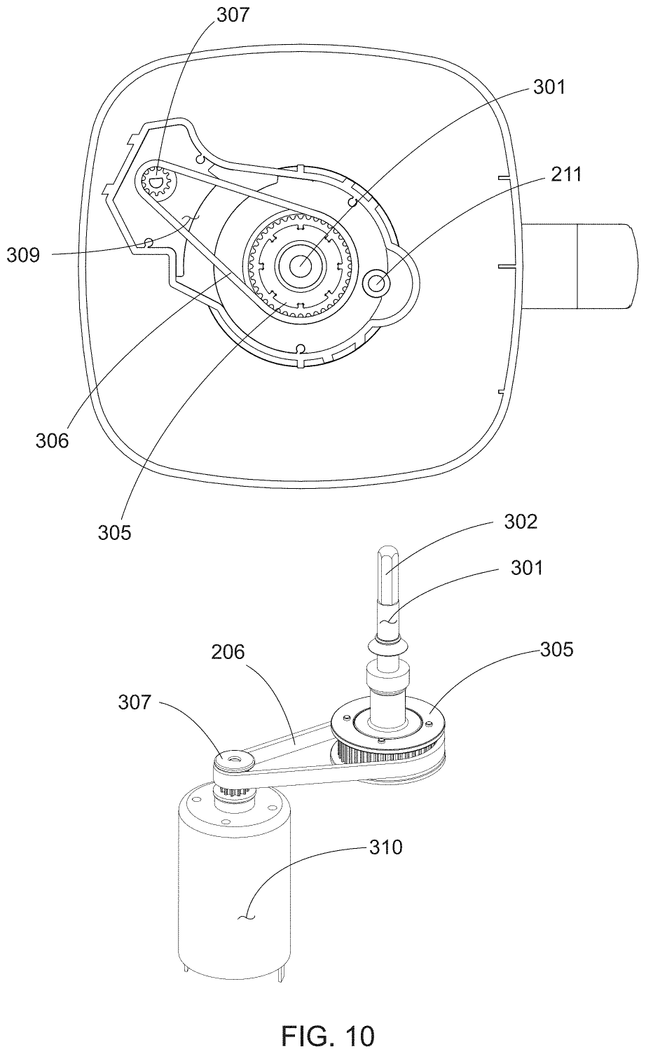

Details relating to the drive system are shown in FIG. 10, including a simplified isometric view of the drive system 300, comprising an electric motor 310, which typically runs at high speed and low torque. This type of motor is chosen since it is compact and relatively low in cost. To use such a motor to drive the blade assembly of the baby food maker requires speed reduction and torque increase, being achieved by using a belt drive, comprising the pulley assembly 305, the belt 306 and the pinion 307, mounted on the motor shaft 311. FIG. 10 also includes a simplified cross sectional view through the drive system enclosure 309 for showing more details of the belt drive system, also shown is the steam tube 211, through which steam passes from the steam chamber, located below the drive system enclosure, to the steam plenum located above the drive system.

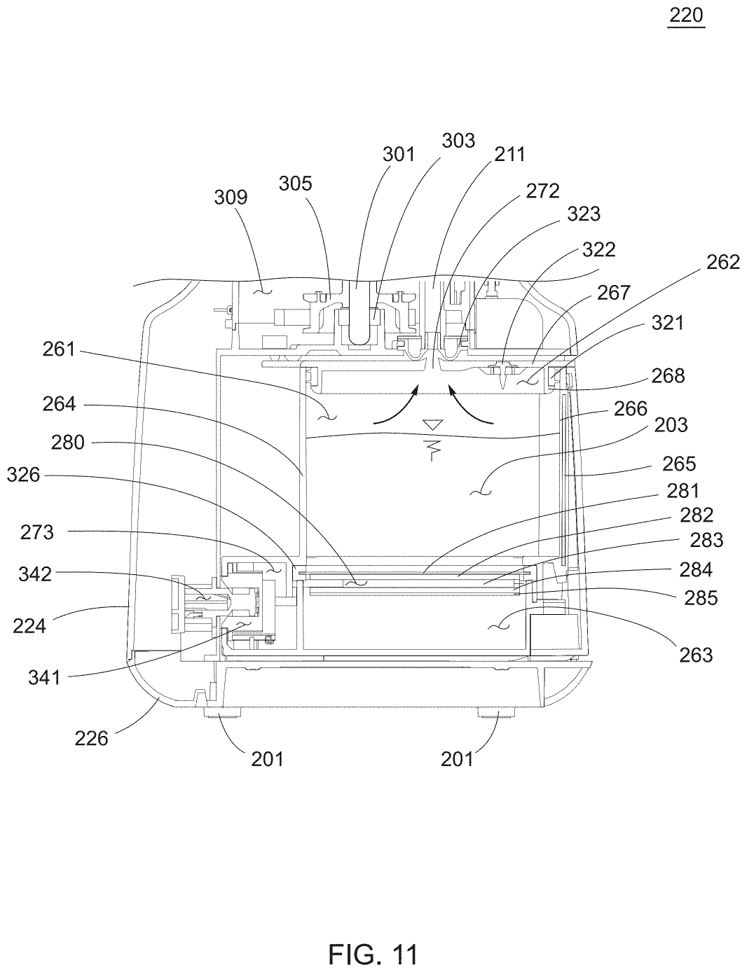

FIG. 11 is an enlarged cross-sectional view of the base 220 portion shown in FIG. 10, including the electric heater assembly 280 comprising a heater cover-plate 281, preferably made of a material that is easy to clean such as stainless steel. The cover plate is sealably secured in place by a gasket 326 at the lower end of the water compartment 261. Underneath the cover-plate is the upper heat-distributing-plate 282 spanning of the surface of the cover-plate to ensure that heat is evenly distributed over the entire surface of the cover-plate; a PTC heating-element 283 is positioned below the upper heat-distribution-plate and supported by another heat-distribution-plate 284; the entire set of plates is being urged toward the heater cover-plate by a retainer 285, such as a bracket or a brace or other means known in the art. The use of a PTC heater is advantageous in this application, among others due to the fact that PTC heaters, being made of a semiconductor with a very steep positive-thermal-coefficient of resistance can be designed to self-regulate at precise pre-specified temperatures, thereby eliminating the need for use of external temperature sensors and controls. Another advantage is derived from the fact that PTC heaters can be formed as flat plates at pre-specified dimensions, suitable for use in the steam chamber of this apparatus. FIG. 11 also shows the electrical connector used to connect and disconnect the steam chamber 260 from the power source in the base 220. The connector includes a “male” portion which is housed in a shield enclosure 273 of the steam chamber 260, and the “female” portion of the connector 342 which is permanently attached to the end of the opening 225 in the base, for allowing the smooth connection and disconnection of the connector components. FIG. 11 also shows the lower steam seal 323 which is permanently connected to the lower end of the steam tube 211 in a manner known in the art. The objective of this seal is to firmly enclose the steam passage from the steam outlet 272 of the lid of the steam chamber and the steam tube 212. In designing the seal several aspects had to be taken into consideration including the fact that the seal must withstand the effect of the steam chamber sliding in and out of the base, and the resulting abrasion, it must also be deigned to continue to seal the passage while the plastic parts expand and contract during the operation of the appliance, and to take into consideration manufacturing tolerances and inconsistency in how the unit is being used. To achieve these and other considerations it was determined that the seal must be designed with a high degree of flexibility, ability to hold its shape at temperatures in the range of 100 C. To that end the seal was designed in the shape of a half a toroid, molded of silicone rubber. Coring out the half toroidal shaped seal or by using material of a very low durometer would be two options to increase pliability.

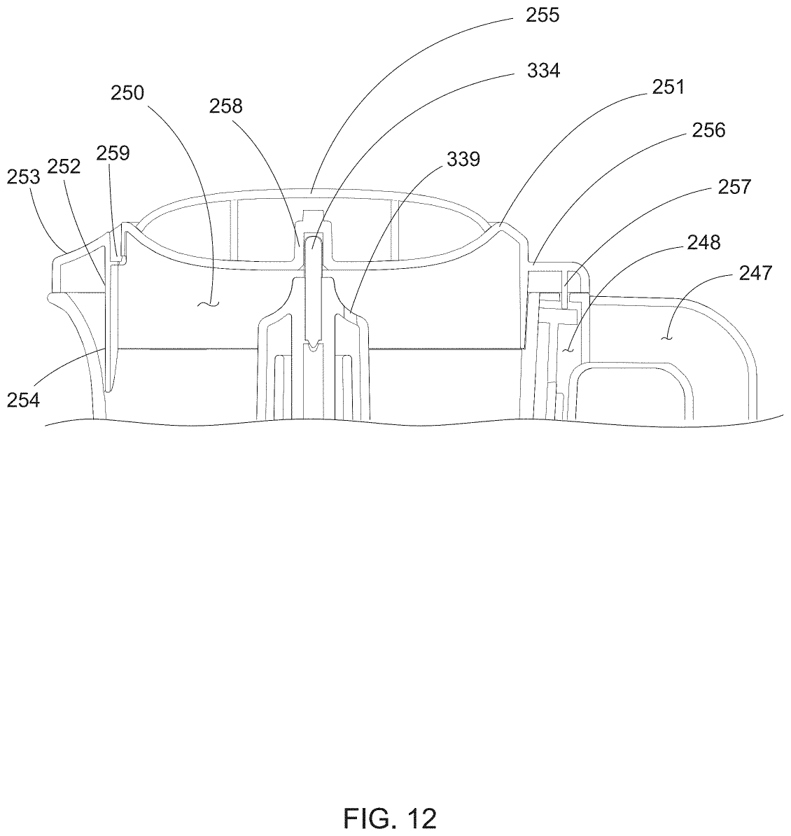

FIG. 12 is an enlarged cross-sectional view of the lid 250 shown in FIG. 10. The lid was designed to play many roles during the operation of the apparatus, for example, it was determined that due to manufacturing tolerances and due to the irregularity of placing the food in the container the blade assembly would occasionally run untrue and would vibrate extensively; in order to overcome that a pin 334 was added to the top of the blade assembly, and a well portion 258 was added to the lid to receive the pin in a friction free manner, to constrain the wobble of the top of the blade assembly. It was also determined that during the chopping and blending operation there was a tendency for the meshed food to rise to the top of the container, and occasionally to settle in the pouring spout area, which is not desirable, to overcome that the lid skirt 252 was extended downwards in the spout area to form a spill guard 254 to overcome that concern. Similarly, it was determined that food would rise along the container wall and splash through the steam vent 259, to avoid that the seam vent was moved inwardly from the side wall of the container.

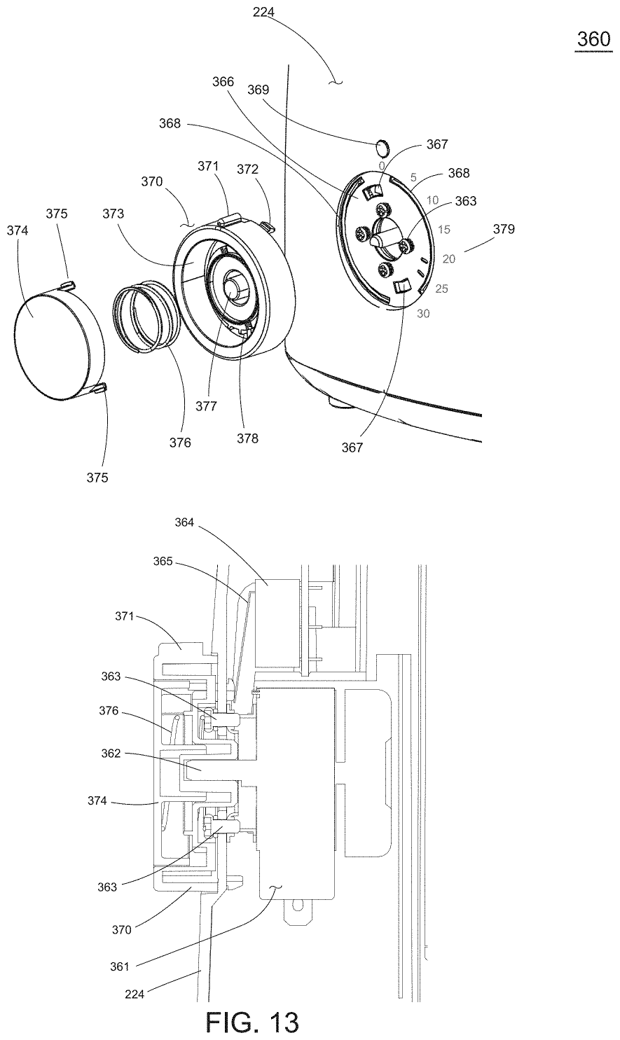

FIG. 13 includes two views of the user-interface assembly 360 of the appliance; one is an isometric exploded view of the parts that are contacted by the user, the other is a partial cross-sectional view of the user interface. Shown in FIG. 13 is a commonly used mechanical timing-switch assembly 361, including a bell that chimes at the end of the cycle. The switch is attached to recess 366 in the base side wall 224 by four screws 363; the recess further includes two long arcuate slots 368 and two apertures 367. The user-interface assembly also includes a micro-switch 364 for energizing the motor 310; the micro-switch has an integral actuating arm 365. The timing-switch shaft 362 projects outward of the base side wall 224 and is connected to the timing dial 370 by collar 377. The timing dial is limited in its turning angle by two snaps 372 that project through arcuate slots 368 in recess 373. Timing dial 370 has a well on its front face for accommodating a pushbutton 374. The pushbutton 374 includes two extensions 375 with side snaps designed to fit through arcuate slots in the timing dial 370 and to protrude through the two apertures 267 in the recess area. The extensions 375, once pushed through the apertures would be prevented from retracting due to the snaps as known in the art. A spring 376, is included to keep the pushbutton at it most extended position. The dial 370 also includes a pointer 371 co-operating with time indicia 379, printed on the side wall 224. An indicator light 369 is tied in with the operation of the user interface, and may be programmed to indicate be in an on or off position, it may be programmed at different frequencies to indicate certain functions, it may also be programmed to change color.

The baby food maker according to the invention was designed for a one-handed use by a parent as frequently the parent will cradle their infant with one arm while being busy preparing food. to that end the unit was designed with non-slip feet 201, which may be fashioned as suction cups, or being made of material with very high friction coefficient. To further facilitate the one-handed operation the steam generator 260 is provided with an easy disengagement set of contacts 341 and 342, for example STRIX Connector P75C1+P75A2 and with a pull handle 267 designed to stay at a temperature which is comfortable for the user to pull, even when water is at boiling temperature. Placing and locking the container 240 in place is facilitated by the large and ergonomically designed handle 247 and by the easy to turn bayonet set 204, 205. Holding and placing the blade assembly is easy due to the length of the body 331 and the distance from its top to the location of the blades 338. The lid handle 255 was designed as a separate part from the lid to maintain its temperatures at a level that is comfortable for the user to lift and turn with one hand. Finally, the user interface was designed for a single-handed operation where the outer rim of the dial will control the steaming time and the inner part of the dial may be pressed with one finger to activate the motor.

The baby food maker according to the invention was designed for maximum safety during operation, for example: the steam generator heater will not operate unless the steam generator lid is in place; the steam outlet 272 is aligned with the lower steam seal 323, which is part of the steam tube 211 and the container and its lid are locked in place. The blade assembly will not operate unless the container and its lid a locked in place. The baby food maker will remain secure in place even if food was unevenly placed in the compartment as the blade assembly 330 is secured at its lower and upper end and would therefore not wobble. Furthermore, as mentioned the feet 201 are designed to secure the appliance in place even if some unbalance food would create some centrifugal forces would be generated during operation.

The baby food maker according to the invention was designed for ease of cleaning. This is exemplified by the steam generator 260 being removed for easy cleaning of the water compartment 261, by the large lid 262, which allow easy access to all corners of the water compartment. The steam passage from the steam outlet to the steam entry into the container inner tube 246 is easy to access for cleaning through the opening of the base seal 325. It should be noted that the container, its lid and the blade assembly, the only parts that come in contact with food were designed of materials that make them dishwasher safe.

I claim:

1. An apparatus for steaming and blending food products and for heating or for sterilizing articles comprising:
a base;
a steam generating chamber supportable on the base and removable therefrom, and including a steam exit port;
a heater for providing heat to the steam generating chamber;
a drive shaft;
an electric motor supported by the base and operatively associated with the drive shaft;
a container assembly positionable on top of the base in an upright orientation and including a container with a steam inlet passage, and a blade assembly disposed within the container;
wherein the container assembly is positionable in the upright orientation relative to the base such that the drive shaft connects to the blade assembly;
wherein the steam exit port is in fluid communication with the steam inlet passage when the steam generating chamber is supported on the base and the container is positioned in the upright orientation relative to the base;
wherein the steam generating chamber comprises a water supply tank with the heater disposed within the water supply tank for generating steam therein; the water supply tank, heater and steam exit port being configured within a singular assembly that is removable as the singular assembly from the base, and the steam generating chamber having electrical contacts extending externally therefrom for electrical disconnection of the heater from the base when the steam generating chamber is removed therefrom;
wherein the container is removable from the base individually of the steam generating chamber;
and wherein the steam exit port is disposed adjacent the top of the steam generating chamber.
